(19) United States
(12) Patent Application Publication
(10) Pub. No.: US 2012/0046798 A1
(43) Pub. Date: Feb. 23, 2012

(54) Systems and Methods for Power Demand Management

(75) Inventors: Frederick L. Orthlieb, Wallingford, PA (US); Alan M. Letzt, Purcellville, VA (US)

(73) Assignee: HEAT ASSURED SYSTEMS, LLC, Wallingford, PA (US)

(21) Appl. No.: 13/213,082

(22) Filed: Aug. 19, 2011

Related U.S. Application Data
(60) Provisional application No. 61/375,130, filed on Aug. 19, 2010.

(51) Int. Cl. G06F 1/30; G06F 1/26

(52) U.S. Cl. 700/297

(57) ABSTRACT

A system and method for shifting power load on a power distribution network with multiple power loads, each of which draws power from the power distribution network. The system includes a controller communicatively coupled to an energy storage system and power load on the power distribution network. The controller is configured to receive a load-shifting signal, determine a load-shifting procedure, and switch one or more of the communicatively coupled power loads from drawing power from the power distribution network to drawing power from the energy storage system according to a load-shifting algorithm.

### CROSS-REFERENCE TO RELATED APPLICATION

Provisional Application No. 61/375,130

### BACKGROUND OF THE INVENTION

1. Field of the Invention

This invention relates generally to the use of power storage technology to provide extended electrical energy backup to systems and appliances in the home when the electric power grid is not operational. More specifically, it relates to a system that allows a homeowner to select which systems and appliances should be connected to a power backup system then provides such power backup from a source other than a generator until the power from the electrical grid is restored or the allocated backup power is exhausted.

2. Description of the Related Art

When the electric grid is unable for any reason to provide electrical power to peoples' homes, then many critical home systems and appliances are unable to operate until such power is restored. Extended grid outages result in severe hardships for individuals, whether they occur in a northern climate during a winter ice storm or in a southern climate during a hurricane. The traditional method for providing such power backup is by connecting an electric generator to the home's electrical system. However, generators may be noisy as well as inconvenient for a homeowner and costly to maintain. This invention addresses a means of providing such power backup without using a generator.

In the prior art, U.S. Pat. No. 6,708,083 discloses a low electric power-consuming heating or cooling system comprising a DC powered microprocessor-based control system and method and a DC powered electrically actuated zone valve. The control system operates on DC power allowing the heating or cooling system to operate independently of electrical utility grid power. This invention discloses methods to minimize electric power consumption. In the prior art, U.S. Pat. No. 7,424,343 describes a system for load control in an electrical power system, wherein one or more data interface devices are provided to a cooling system. A remote monitoring system sends one or more commands to the data interfaced devices to adjust loading on the electrical power system, which may be shutdown commands or commands to tell a compressor in the cooling system to operate in a low-speed or low-power mode. What is needed is a method to determine when electric power backup is required for the heating or cooling system when efficient components and operational adjustments are insufficient and how to switch between the electric grid system and a power storage system at the correct time.

In the prior art, U.S. Pat. No. 7,389,159 presents a scheme for adaptive control of variable or multispeed hot air furnace blowers that adjust operation based on the outdoor temperature and the house's response to heat input during power down conditions. However, what is needed is a system that addresses the disruption of electric power to the boiler, zone valves, and additional electrical appliances. What is also needed is a system that addresses management of the energy storage system when the electric power grid is both operational and non-operational.

The prior art also describes battery backup systems for information storage and retrieval systems, (U.S. Pat. No. 7,659,697), as well as vehicle engines, (U.S. Pat. Nos. 6,747,371 and 6,734,61) and telecommunications support (U.S. Pat. No. 6,115,276) but none of these provide the technology and methods required for control and operation of a battery backup system for use with home heating systems and other home appliances that have their own particular sets of operational characteristics and requirements and benefit from control of key parameters by the home owner.

### BRIEF SUMMARY OF THE INVENTION

Electricity continues to be consumed at higher and higher rates, as consumers purchase portable electronic devices, computers, and even electric automobiles in the near future. The sheer amount of electricity that must be generated and transported to consumers places a large strain on transmitting and production facilities. In particular, in order to avoid brownouts or blackouts, utilities that supply electricity to customers must make sure that they have sufficient generation capacity to satisfy demand, even at peak demand periods such as the early evening. Generation capacity is generally increased by adding the output of one or more power generating plants to the power grid—quite often referred to as bringing one or more power generating plants “online” to respond to increase power demand.

However, since electricity demand is cyclical, it is not cost-efficient to maintain spare generating capacity (e.g., an additional power generating plant) that is only used periodically. Moreover, as total electricity demand continues to rise, adding extra generating capacity becomes difficult, due to community and political resistance toward constructing power-generating facilities—both in terms of the location of additional power generating plants and additional transmission and distribution power lines. Therefore, utilities that supply electricity to customers desire a means for addressing the cyclical nature of electricity demand to avoid the need for building excess power generating capacity.

A transformation of the power grid in the United States and other countries to a more efficient system has already begun—the so-called “Smart Grid” transformation or revolution. In order to better measure power demand, several utilities have begun installing electronic power consumption meters (“smart meters” in their customers' facilities. Smart meters will eventually allow for (i) measurement of power consumption in real-time or near real-time and (ii) “dynamic pricing”, i.e., adjustment of pricing of the electricity consumed based at least in part on an aggregate measure of power consumption across a segment of customers, e.g., the buildings in a particular United States zip code. As the Smart Grid revolution progresses, consumers face high electricity prices during peak demand periods. However, many of these consumers may not want the inconvenience of monitoring their electric energy consumption so as to reduce consumption during peak demand periods by turning off some of the loads in their buildings. Therefore, consumers desire a means for addressing the dynamic pricing of electricity to avoid high electricity prices during peak demand periods. This means would preferably not burden the consumer with continuous monitoring of their electricity consumption.

The methods, systems, and devices described herein address these and other needs. According to one aspect of the invention, a system and method for distributing cyclical power demand is provided, by drawing on locally-stored energy during periods of high electricity demand. Local energy storage systems that allow the operating of electrical equipment even in the event of a power or grid outage are desirable for consumers for many reasons, such as for the operation of life support equipment or to provide heating and cooling in regions with extreme conditions. By charging local energy storage systems during periods of low demand and using the locally-stored energy to power appliances during periods of high demand, the cyclical nature of electricity demand can be alleviated—from the perspective of both consumers and the utilities that supply these consumers with electricity.

For example, if a thousand homes each had local energy storage capability of about two kilowatt-hours at peak demand periods (which may last 3-4 hours), the load on the grid may be reduced by as much as two megawatt-hours during the peak demand period. For most utilities, this may be a significant amount of power and the reduction in load in this manner during those peak demand periods could prevent a brownout or blackout from occurring.

### BRIEF DESCRIPTION OF THE SEVERAL VIEWS OF THE DRAWINGS

The foregoing and other objects and advantages of the invention will be appreciated more fully by reference to the following drawings which are for illustrative purposes only:

FIG. 1 is a diagram of an illustrative power distribution system, according to an embodiment of the invention;

FIG. 2 is a chart depicting illustrative power demand and generation curves versus time, according to an embodiment of the invention.

FIG. 3 is a diagram depicting power distribution local to a consumer, according to an illustrative embodiment of the invention;

FIG. 4 is a detailed diagram of a first illustrative consumer power distribution system, according to an embodiment of the invention;

FIG. 5 is a detailed diagram of a second illustrative consumer power distribution system, according to an embodiment of the invention;

FIG. 6 is a diagram of an illustrative consumer power distribution controller, according to an embodiment of the invention; and

FIG. 7 is a flowchart depicting an illustrative process for power demand leveling, according to an embodiment of the invention.

### DETAILED DESCRIPTION OF THE INVENTION

To provide an overall understanding of the invention, certain illustrative embodiments will now be described, including systems and methods for power demand leveling. However, it will be understood by one of ordinary skill in the art that the systems and methods described herein may be adapted and modified for other suitable applications and that such other additions and modifications will not depart from the scope thereof.

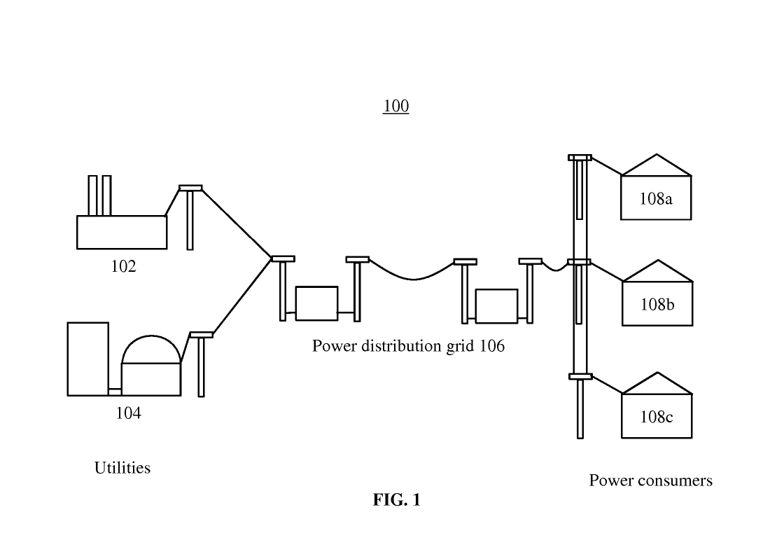

FIG. 1 depicts a system 100 for distributing power between power generators such as utilities and power consumers. Utilities 102 and 104, each of which generate power for sale to consumers, are linked to a power distribution grid 106. Power consumers 108a-d are also linked to the power distribution grid 106, and may receive 2 power generated by utility 102 and/or utility 104. Power consumers may be residential households, commercial properties, industrial operations, or any entity that uses electric power.

While two utilities and four power consumers are depicted in FIG. 1, it should be understood that more or fewer utilities and/or power consumers may be linked to the power distribution grid 106. For example, in some embodiments only one utility may be linked to the power distribution grid 106, or fewer than three power consumers may be linked to the grid 106. Similarly, three or more utilities and/or four or more power consumers may each be linked to the power distribution grid 106. In some embodiments, at least one of the power consumers, 108a-d, may also generate power, and the power distribution grid 106 may not be connected to any utility. Utilities 102 and/or 104 may include fossil fuel-based power generators, such as power plants fired by coal, oil, natural gas, or any other hydrocarbon derivative, including biomass. Utilities 102 and/or 104 may also include nuclear, hydroelectric, geothermal, solar, wind, tidal, or any other power generators or plants.

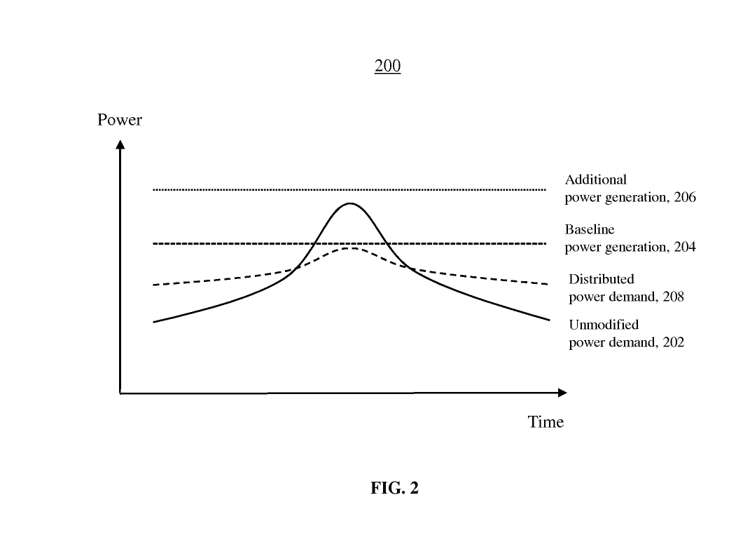

FIG. 2 is a chart 200 depicting illustrative power demand and generation curves versus time, according to an embodiment of the invention. Curve 202 depicts an unmodified power demand curve as a function of time. The unmodified demand curve 202 depicted is not uniform, because consumer power demand over a period of time (e.g., a day) may vary significantly. For example, household power demand may be low during the day, when many consumers are at work, but may peak in the late afternoon and evening, as consumers return home after work and begin using household electronic devices such as washers or dryers. As another example, industrial power demand may be high during periods when high-powered electronic machinery is operating, but may be low when the machinery is not operating.

Curve 204 depicts an example of a baseline power generation level. A utility may operate its generators at its power generating plants so as to provide a certain minimum or baseline power level. The baseline power level may be determined by the utility and/or the particular generation equipment. For example, operating generators may be able to supply a certain minimum power level and no less—possibly determined by the number of “online” power generating plants. In some embodiments, a utility may select the baseline power level based on operating and cost criteria. For example, it may be most cost-effective to operate generators at power generating plants at a particular baseline power generation level.

As shown in chart 200, unmodified power demand (curve 202) may exceed the baseline power generation level (curve 204) at certain times, e.g., during a hot day in the summer when consumers are using their high energy-consuming air conditioning systems. This may occur because a utility may not set its baseline power generation level high enough to account for all power demand peaks. For example, a utility may find it undesirable to set its baseline power generation level high enough to account for all (or even most) potential power demand peaks, because of the costs and potential wasted power associated with the high baseline generation level. In these situations, when the unmodified power demand curve 202 exceeds the baseline power generation curve 204, a utility must provide additional power in order to avoid interruption of a stable power supply to consumers, such as brownouts or blackouts. The utility may switch on other generators (e.g., at one or more additional power generating plants) to provide this additional power, depicted as the additional power generation curve 206. However, these other generators may be more expensive to operate than the baseline power generators, and may also take time to ramp up when turned on, which may result in power interruptions. Alternatively, a utility may buy additional power from another utility in a nearby geographic location. In some instances, currently existing power generator capacity may be insufficient to prevent power interruptions, and additional power plants may need to be constructed, which would require lengthy, difficult, and expensive approval and construction processes.

According to one embodiment of the invention described herein, the power demand curve 202 may be modified by using distributed local energy storage to result in the distributed power demand curve 208. For example, when power demand approaches the baseline power generation level, locally-stored energy may be used to supplement the baseline power, thus avoiding the need to switch on additional power generators. Energy may then be stored locally during periods of low power demand (e.g., when the unmodified power demand curve 202 is far below the baseline power generation curve 204). Thus, peaks in power demand may be lowered, at the cost of raising power demand at other, non-peak periods. If electricity is dynamically priced such that electricity cost is higher during peak demand periods, the lowering of the peaks in power demand will not only benefit the utilities, but will also benefit the consumers as their electricity costs during peak power demand periods will decrease.

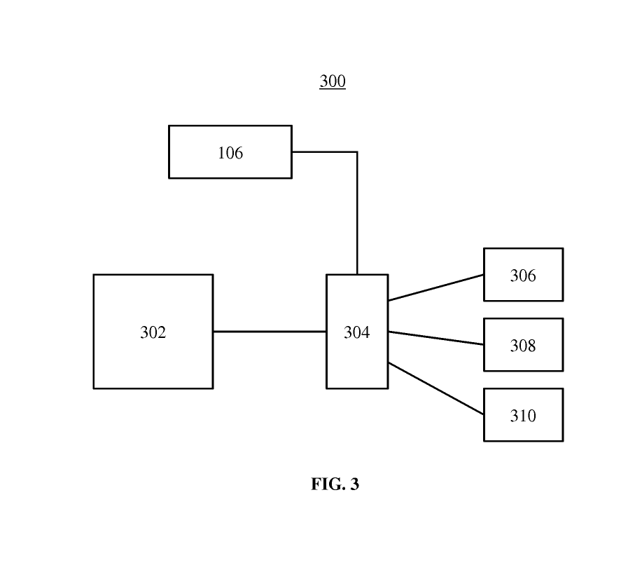

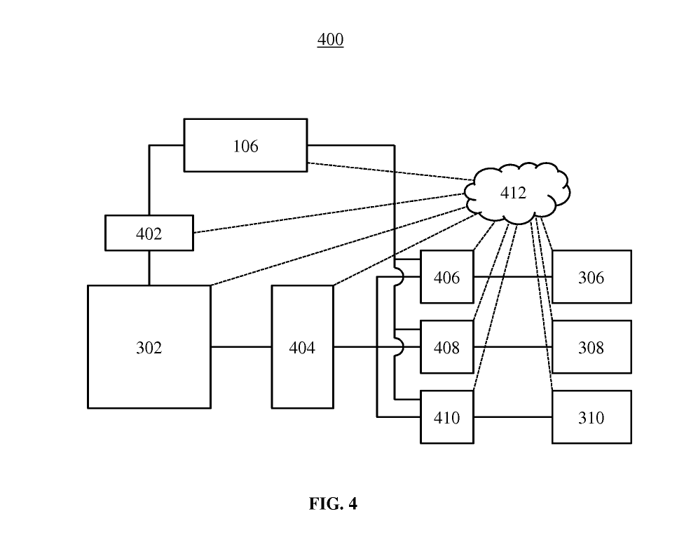

FIG. 3 depicts a system 300 for distributing power local to a consumer, for example within a household or facility of a consumer, such as consumers, 108a-d, described above in relation to FIG. 1. The system 300 includes a consumer energy storage system 302, a consumer power distribution controller 304, and consumer appliances 306-310. The consumer power distribution controller 304 is connected to the consumer energy storage system 302 as well as the power distribution grid 106 (see FIG. 1), and the consumer appliances 306-310. The consumer power distribution controller 304 is responsible for routing power between the power distribution grid 106 and/or the consumer energy storage system 302 and the consumer appliances 306-310. In some embodiments, the consumer power distribution controller 304 is responsible for routing power between the power distribution grid 106 and the consumer energy storage system 302, for example to recharge the energy storage system 302 by routing power from the grid 106 to the storage system 302, or to supply power to the grid 106 by routing power from the storage system 302 to the grid 106. Examples of consumer power distribution controllers are described further below, in relation to FIGS. 4-6.

In some embodiments, the consumer energy storage system 302 includes one or more energy storage elements, such as batteries, fuel cells, and double-layer capacitors (not shown). For example, the consumer energy storage system 302 may include batteries configured to operate as an energy storage system, such as batteries linked in a parallel and/or serial configuration. In certain embodiments, the consumer energy storage system 302 may include absorbent glass mat (AGM) lead-acid batteries connected in parallel or series. For example, Sunxtender batteries, such as PVX-130T batteries or PVX-1080T batteries, manufactured by Concorde Battery Corporation, West Covina, Calif. may be used. The number and type of batteries used in the consumer energy storage system 302 may be based on a determination of how much electrical load/consumption is to be shifted or distributed. For example, if two kilowatts need to be shifted for four hours, then 10 PVX-1080T batteries may be used. In other embodiments, any other suitable type of battery or batteries may be used, and the number and type of batteries used in the consumer energy storage system 302 may be based on any other suitable factor or variable. In some embodiments, the consumer energy storage system 302 may include processing circuitry configured to monitor the performance and condition of the consumer energy storage system 302 and/or the energy storage elements included in the energy storage system 302.

In some embodiments, the energy storage system 302 may include energy storage elements other than batteries, as well as converters for converting electrical energy into other forms of energy. For example, the energy storage system 302 may include capacitors to store energy as electricity, kinetic energy storage (e.g., flywheels), thermal energy storage (e.g., thermal reservoirs), and/or potential energy storage (e.g., elevated mass). The energy storage system 302 may also store energy by converting electricity into other products, such as hydrogen (e.g., electrolysis). The consumer appliances 306-310 may include electrically-powered household appliances and devices such as ovens, microwaves, toasters, refrigerators, computers, and/or any other electrically-powered household devices. In some embodiments, the consumer appliances 306-310 may include one or more heating, ventilation, or air conditioning device. For example, the appliances may include an electric heater, an electric pilot light for a furnace, and/or an air conditioner.

In certain embodiments, the system 300 may also include one or more consumer power generators (not shown), such as solar panels, wind turbines/generators, portable generators, or any other power generator suitable for installation in a consumer home or facility. These consumer power generators may be connected to the consumer power distribution controller 304, which may route power between the consumer power generators, the appliances 306-310, the consumer energy storage system 302, and/or the power distribution grid 106.

FIG. 4 depicts a detailed diagram of an example of a consumer power distribution system 400, according to an illustrative embodiment of the invention. The system 400 includes a consumer energy storage system 302 and consumer appliances 306-310, described above in relation to FIG. 3, which are connected to a power distribution grid 106 (see FIGS. 1 and 3). The system 400 also includes an energy storage charging system 402, a power conversion system 404, and switches 406-408. The energy storage charging system 402 controls the transfer of power between the power distribution grid 106 and the consumer energy storage system 302. For example, the charging system 402 may provide power from the distribution grid 106 to the energy storage system 302 in order to charge the energy storage system 302. In some embodiments, the charging system 402 includes circuitry configured to convert power provided from the grid 106 into power suitable for charging the energy storage system 302. For example, the charging system 402 may be configured to convert alternating current (AC) electricity into direct current (DC) electricity, or vice versa. Similarly, the charging system 402 may also be configured to transfer power from the energy storage system 302 to the distribution grid 106 to increase the amount of power available on the distribution grid 106 to, for example, other consumers connected to the distribution grid 106. In some embodiments, the power conversion system 404 converts power provided by the consumer energy storage system 302 into power suitable for the consumer appliances 306-310. For example, the consumer energy storage system 302 may provide DC electricity, whereas one or more of the consumer appliances 306-310 may require AC electricity. The power conversion system 404 may then convert the DC electricity from the storage system 302 into AC electricity for the consumer appliances 306-310. In some embodiments, the power conversion system 404 may include an inverter for performing the DC-AC conversion.

In certain embodiments, the switches 406-410 control the flow of power from the distribution grid 106 and/or the consumer energy storage system (via the power conversion system 404) to each of the appliances 306-308. The switches 406-410 may be configured to control the flow of power to a particular appliance. For instance, switches 406-410 may pass either grid power from distribution grid 106 or power from the consumer energy storage system to the particular appliance.

While in FIG. 4, each switch is coupled to one appliance, in other embodiments, a single switch may be coupled to multiple appliances. For example, a single switch may control power flow to all the appliances in a particular room, or all appliances of a particular type (e.g., cooking, heating, entertainment, etc.).

In some embodiments, each of switches 406-410 may include multiple switches, for example a switch for switching between grid and stored power and a switch for controlling power flow between the grid and/or stored power and an appliance. As described below with respect to FIGS. 4-6, the switches 406-410 may be configured to be controlled locally and/or remotely. For example, the switches 406-410 may be controlled locally (e.g., by a consumer manually actuating the switches), or remotely via hard-wired connections (e.g., Ethernet, USB, serial/parallel, and/or power line connections) and/or wireless connections (e.g., Wi-Fi, cellular/satellite networks, and/or RF/IR). The switches 406-410 may include one or more of a solid state relay, power MOSFETs, IGBTs, JFETs, transfer switches, or any suitable power switching device. In some embodiments, transfer switches may be used to switch between grid power and stored power. Examples of transfer switches may include 32311-189EF switches manufactured by GenTran Corporation, Alpharetta, Ga.; 3231-UTS6BI switches manufactured by APC Corporation, W. Kingston, R.I.; and/or 32316-30216A1 switches manufactured by Reliance Control Corporation, Racine, Wis. Optionally, any other suitable transfer switches may be used.

In some embodiments, power MOSFETs, IGBTs, and JFETs may be used to control the power flow from grid power and/or stored power to individual (or multiple) appliances. Examples of suitable switches may include RFP1N1 switches manufactured by Intersil Corporation, Milpitas, Calif., and/or 2N676 switches manufactured by Fairchild Semiconductor, South Portland, Me. Optionally, any other suitable power switches may be used. Switching between grid power and stored power may occur to control the power flow from grid power and/or stored power to individual (or multiple) appliances, or may occur during brownout or blackout situations to provide backup power to one or more of the consumer appliances. Thus, system 300 (FIG. 3) or 400 (FIG. 4) can act to provide backup power in addition to distributing power demand in a suitable manner.

In some embodiments, system 300 or 400 can be configured to measure a level of power received by a consumer from the power distribution grid, and in response to this measure, determine if a brownout or blackout condition exists. In one embodiment, if a brownout or blackout condition exists, one or more appliances are powered by the consumer energy storage system 302.

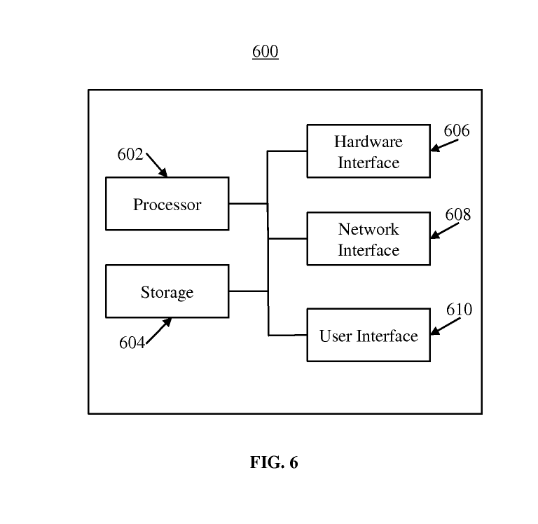

In some embodiments, each of the elements described above may be configured to communicate with a network 412, as denoted by the dashed connectors. The network 412 may be a local area network, a wide area network, or the Internet. Each individual element, such as the grid 106, the appliances 306-310, the energy storage system 302, charging system 402, conversion system 404, and the switches 406-410, may include circuitry configured to communicate to other elements or to local/remote servers via the network 412, such as the circuitry described below in relation to FIG. 6. The individual elements may be configured to communicate via wired or wireless communication systems. For example, the individual elements may communicate via dedicated data lines, power lines, or wirelessly, via Wi-Fi, cellular networks, satellite networks, or any other suitable communication system or protocol. The elements may be configured to collect and transmit data to other elements or to local/remote servers. In some embodiments, data about total energy usage, energy usage timing, efficiency, and other parameters may be collected and/or transmitted. For example, individual elements may include sensors for determining energy usage, as well as processing circuitry for determining total energy usage, timing, efficiency, and/or other parameters.

In some embodiments, instructions may be provided to individual elements via the communication links, and individual elements may include circuitry configured to execute received instructions. For example, appliances may be instructed to turn on or turn off at certain times or when certain criteria are met, switches may be instructed to switch between providing grid power and stored power to appliances based on certain criteria, and the energy storage system 302/charging system 402 may be instructed to charge from the grid 106 when particular criteria are met. These criteria may include, for example, time, power cost, local power usage, power usage over the entire grid 106, requests from a utility or a consumer, or any other suitable parameter.

In some embodiments, the system 400 may also include one or more consumer power generators (not shown), as described above in relation to FIG. 3. These consumer power generators may be coupled to the appliances 306-310 (via switches 406-410), the energy storage system 302 (via the charging system 402 or via a different conversion system), and/or to the grid 106.

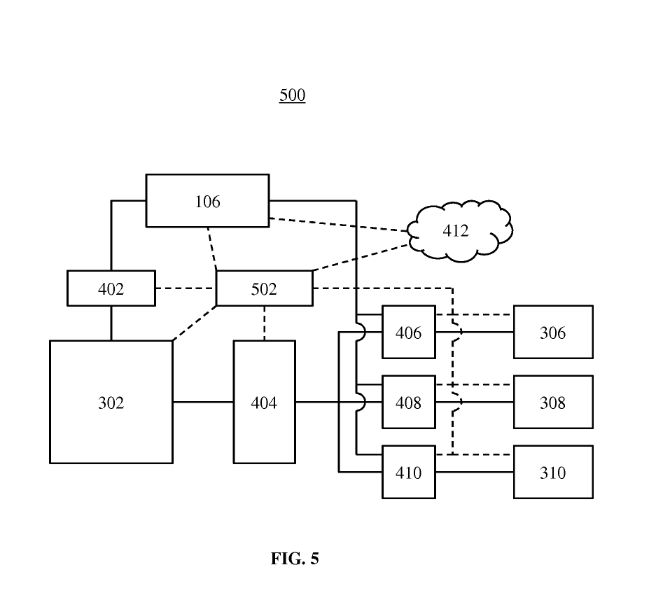

FIG. 5 depicts a detailed diagram of an example of a consumer power distribution system 400, according to an illustrative embodiment of the invention. The system 400 includes a consumer energy storage system 302, consumer appliances 306-310, charging system 402, power conversion system 404, switches 406-410, and interfaces to the power grid 106. In some embodiments, these elements are similar to those described above in relation to FIGS. 1 and 3-4. The power distribution system 00 also includes a consumer power controller 02, configured to control the operation of various elements in the system 400. For example, the consumer power controller 02 may coordinate the operations of the consumer energy storage system 302, the charging system 402, the power conversion system 404, the switches 406-410, and/or the appliances 306-310. In some embodiments, processing capability may be moved from the individual elements and consolidated in the controller 402, resulting in the reduction of complexity and cost for individual elements. While in the depicted embodiment, the various elements communicate directly with the controller 402, in other embodiments the controller may communicate with the various elements through the network 412, as well as the grid 106, as described above in relation to FIG. 4.

FIG. 6 depicts an illustrative consumer power distribution controller 600, similar to controller 02 described above in relation to FIG. 4, according to an embodiment of the invention. The controller 600 comprises at least one processor 602 and storage unit 604, which includes at least one random access memory (RAM), at least one read-only memory (ROM), and/or one or more data storage devices (not shown). The controller 600 also includes at least one network interface unit 608, a user interface unit 610, and a hardware interface unit 606. All of these latter elements are in communication with the processor 602 to facilitate the operation of the controller 600. The controller 600 may be configured in many different ways. For example, controller 600 may be configured to operate in a standalone fashion or, alternatively, the function of controller 600 may be distributed across multiple processor systems and architectures. The various components of the controller 600 may be disposed locally or remotely from each other. Controller 600 may be configured in a distributed architecture, wherein databases and processors are housed in separate units or locations. Some such units perform primary processing functions and contain at a minimum, a general controller or a processor 602 and a storage unit 604. In such an embodiment, each of these units is attached via the network interface unit 608 to a communications hub or port (not shown) that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, BLUETOOTH™, GSM and TCP/IP.

The processor 602 may include one or more microcontrollers, microprocessors, and/or supplementary co-processors such as math co-processors. For example, in one embodiment, a PIC microcontroller manufactured by Microchip Technology Inc, Chandler, Ariz., may be used. Optionally, any other suitable controller, microcontroller, processor, or microprocessor may be used. The processor 602 is in communication with the network interface unit 608 and the user interface unit 610, through which the processor 602 communicates with other devices such as other servers, user terminals, or devices. The network interface unit 608 and/or the user interface unit 610 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The processor 602 is in communication with the user interface unit 610, which allows a user or consumer to interact with or view data about the controller 600 and/or the overall system. The user interface unit 610 may include devices for displaying or providing data to a user, such as a video display, audio speakers, indicator lights, or any other suitable output device. The user interface unit 610 may also include input devices with which a user may interact with the controller 600 and/or the overall system. For example, input devices may include keyboards, buttons, switches, pointing devices (e.g., mice, trackballs, joysticks, and touch pads), microphones (e.g., for voice recognition), or any other suitable input device. In some embodiments, the user interface unit 610 may be disposed remote to the controller 600. For example, a consumer may interact or interface with the controller 600 and/or the processor 602 via a remote interface, such as a web portal or an application on a portable or remote device.

The processor 602 also communicates with a hardware interface unit 606, via which the processor 602 may provide instructions to various hardware components of a power distribution system. For example, the hardware interface unit may be configured to communicate with energy storage system 302, charging system 402, power conversion system 404, switches 406-410, and/or appliances 306-310. In some embodiments, the processor 602 may be configured to communicate directly with the aforementioned system components.

The processor 602 is also in communication with the storage unit 604. The storage unit 604 may comprise an appropriate combination of magnetic, optical and/or semiconductor memory, and may include, for example, RAM, ROM, flash drive, an optical disc such as a compact disc and/or a hard disk or drive. The processor 602 and the storage unit 604 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the processor 602 may be connected to the storage unit 604 via the network interface unit 608.

The storage unit 604 may store, for example, (i) an operating system for the controller 600; (ii) one or more applications (e.g., computer program code and/or a computer program product) adapted to direct the processor 602 in accordance with the present invention, and particularly in accordance with the processes described in detail with regard to the processor 602; and/or (iii) database(s) adapted to store information that may be utilized to store information required by the program.

The operating system and/or applications may be stored, for example, in a compressed, an uncompiled and/or an encrypted format, and may include computer program code. The instructions of the program may be read into a main memory of the processor from a computer-readable medium other than the storage unit 604. While execution of sequences of instructions in the program causes the processor 602 to perform the process steps described herein, hard-wired circuitry may be used in place of, or in combination with, software instructions for implementation of the processes of the present invention. Thus, embodiments of the present invention are not limited to any specific combination of hardware and software. Suitable computer program code may be provided for performing numerous functions such as generating dynamic driver profiles, evaluating driver behavior, selecting feedback modes, and generating feedback. The program also may include program elements such as an operating system, a database management system and “device drivers” that allow the processor to interface with computer peripheral devices (e.g., a video display, a keyboard, a computer mouse, etc.) via user interface 610.

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASHEEPROM, any other memory chip or cartridge, or any other medium from which a computer can read.

\

Various forms of computer readable media may be involved in carrying one or more sequences of one or more instructions to the processor 602 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

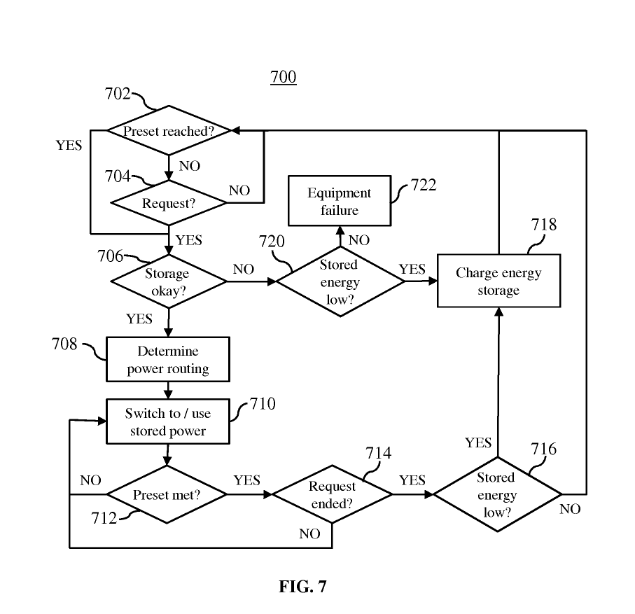

FIG. 7 is a flowchart depicting an illustrative process 700 for power demand leveling using locally-stored energy, according to an embodiment of the invention. In some embodiments, this process may be performed by the consumer power controller 702 (FIG. 7), or the processor 602 in the power distribution controller 600 (FIG. 6). In certain embodiments, the process may be performed by multiple processors or controllers operating together. The power demand leveling process 700 may occur due to a preset parameter limit being reached, or due to a consumer or utility request. In step 702, it is determined if a preset parameter limit or threshold has been reached. Examples of parameters that may have associated limits/thresholds include power price, load on the power distribution grid 106 (FIG. 1), load on the local/consumer power distribution system (e.g., load due to operating appliances), power being provided by consumer power generators (e.g., solar panels, wind turbines, etc.), time of day/month/season, or any other relevant parameter. These parameter limits/thresholds may be preprogrammed into the system or provided to the controller by the utility, the consumer/user, or any other third party, for example over network 412 (FIG. 4) or via user interface 610 (FIG. 6). If at least one parameter limit or threshold has been reached, the process moves to step 706, discussed below in further detail. If it is determined that no parameter limits or thresholds have been reached in step 702, the process proceeds to step 704, in which it is determined if a request to switch to locally-stored energy has been received, from the utility and/or the consumer. As with parameter limits and thresholds, these requests may be received from the utility, the consumer/user, or any other third party, for example over network 412 or via user interface 610. If no such request has been received, the process loops back to step 702.

In some embodiments, the process may wait for a particular time interval before performing the limit/threshold determination again. This time interval may be preset or specified by a user/third party. If, however, a request has been made in step 704, or if a limit/threshold was reached in step 702, a determination is made as to the status of the consumer energy storage system in which energy is stored locally, similar to consumer energy storage system 302 described above. The determination may be made by the controller 702 and/or the consumer energy storage system 302, itself. If the status of the energy storage system is not “okay” (i.e., there is a problem with the energy storage system), the process moves to step 720, where it is determined if the problem is that there is insufficient stored power. If so, the process moves to step 718, in which the energy storage is charged, and the proceeds back to step 702.

In some embodiments, instead of charging the energy storage, the process may simply abort, and continue using power from the grid 106. For example, if the storage check occurs because a utility has requested the switch to local energy storage, it may be undesirable for charging of the local energy storage to occur, because the charging and the normal consumer power use would drain more power from the grid 106 at the exact time that the utility desired to lessen the load on the grid. If the problem with the energy storage system is not low stored energy, the process may move to step 722 and abort.

If the determination of energy storage condition in step 706 is acceptable, then the process moves to step 708, during which the exact power routing is determined. By appropriately configuring the switches 406-410, all, some, or none of the appliances 306-310 may be powered by stored energy instead of energy from the power grid. The determination of exactly which appliances should be powered by what power source may be performed based on a number of parameters. For example, if a preset grid power usage threshold was exceeded in step 702, or if a request from a utility to reduce power usage below a certain threshold was received in step 704, the system may determine which of the currently operating appliances should be operated from stored energy and which of the currently operating appliances should be operated from the grid.

As one example, if a washing machine, a microwave, and a refrigerator are currently operating, and the removal of either the microwave or the combination of the washing machine and the refrigerator from the grid would bring the total grid power usage down below a preset threshold, then the system may determine that either the microwave should be powered from stored energy or the washing machine/refrigerator combination should be powered from stored energy. In some embodiments, the power routing in step 708 may also turning off one or more appliances. This may be performed by the controller directly turning appliances off (if the controller is in direct communication with the appliances), or by configuring the switch associated with a particular appliance to provide no power (i.e., provide neither grid power nor stored energy). For example, a consumer desiring to be “green” may set restrictions on appliance use (e.g., no microwave use or no washing machine/dryer use) during high-demand periods. As described above, the switch can be in communication with the controller via a hardwired and/or wireless connection.

To make the routing determination, other parameters may also be taken into account. For example, each appliance may have a particular grid power priority associated with it, and the routing determination may be made to allow appliances with higher grid power priorities to be powered by the grid, and appliances with lower grid power priorities to be powered by stored energy. In some embodiments, a similar priority system may exist with respect to stored energy (i.e., appliances with higher stored energy priorities are allowed to operate from stored energy preferentially over appliances with lower stored energy priorities). Other parameters that may be used in the routing decision include power cost, amount of currently stored energy, number of operating appliances, type of operating appliances, total power draw of operating appliances, time of day, or any other suitable parameter. Once the power routing determination has been made in step 708, the process moves to step 710, where the power routing and switching is performed. At step 712, a determination is made as to preset parameter limits or thresholds have been achieved. If not, the process moves back to step 710, and the system continues to operate according to the power routing determined in step 708. If the limits/thresholds have been achieved, then the process moves to step 714, where it is determined if a consumer/utility request has ended, or if it is still outstanding. If it has not ended, the process moves to step 710, and the system continues to operate according to the power routing determined in step 708. If the request has ended, the process moves to step 716. In some embodiments, the power routing determination in step 708, instead of only being made once per cycle, may be performed dynamically, based on changes in the system. For example, if appliances are turned on or off, or if a certain time interval has passed, the power routing determination may be made anew.

In step 716, it is determined if stored energy is below a particular threshold which may be preset or dynamically specified by a consumer or utility. If not, the process moves to step 702. If so, the process moves to step 718, where the energy storage is charged from the grid. In some embodiments, the system may determine that while the energy storage should be charged, it should be charged at a later time, for example, due to high power cost. In these embodiments, the system may delay the recharging step until power costs have dropped sufficiently to, for example, meet a cost threshold.

Variations, modifications, and other implementations of what is described may be employed without departing from the spirit and scope of the invention. More specifically, any of the method and system features described above or incorporated by reference may be combined with any other suitable method or system feature disclosed herein or incorporated by reference, and is within the scope of the contemplated inventions. The systems and methods may be embodied in other specific forms without departing from the spirit or essential characteristics thereof. The foregoing embodiments are therefore to be considered in all respects illustrative, rather than limiting of the invention. The teachings of all references cited herein are hereby incorporated by reference in their entirety.

The invention claimed is:

1. A system for managing power demand comprising:
at least one switch configured to:
in a first configuration, power an electrical device with a consumer energy storage system and,
in a second configuration, power the electrical device with a power distribution grid; and
a processor, configured to:
determine if the electrical device is to be powered by a different power source, and in response to the determination:
instruct the at least one switch to operate in the second configuration if the at least one switch is currently in the first configuration and;
instruct the at least one switch to operate in the first configuration if the at least one switch is currently in the second configuration.

2. The system of claim 1, wherein the consumer energy storage system comprises batteries.

3. The system of claim 1, wherein the consumer energy storage system comprises at least one fuel cell.

4. The system of claim 1, wherein the processor is configured to determine if the electrical device is to be powered by a different power source based on instructions provided by at least one entity.

5. The system of claim 4, wherein the entity comprises a utility or consumer.

6. The system of claim 5, wherein the consumer includes a residential, commercial or industrial consumer.

7. The system of claim 1, wherein the processor is configured to determine if the electrical device is to be powered by a different power source by comparing power usage with at least one threshold.

8. A method for managing power demand comprising:
determining, with a processor, if an electrical device powered in a first configuration with a consumer energy storage system and powered in a second configuration with a power distribution grid is to be powered by a different power source, and
in response to the determining, powering the electrical device in the second configuration if the electrical device is currently powered in the first configuration and powering the electrical device in the first configuration if the electrical device is currently powered in the second configuration.

9. A method for managing power demand comprising:
receiving an input from an entity over a communications interface;
determining, based on the received input, if an electrical device powered in a first configuration with a consumer energy storage system and powered in a second configuration with a power distribution grid is to be powered by a different power source; and
in response to the determining, powering the electrical device by the different power source.

10. The method of claim 9, wherein the entity is one of a consumer or a utility.

11. The method of claim 10, wherein the consumer is a residential, industrial or commercial consumer.

12. The method of claim 9, wherein the communications interface includes at least one of an Internet interface, a power line interface, a hardwired interface, a wireless interface, a cellular interface, and a satellite interface.

13. The method of claim 9, wherein the input includes a threshold for power consumption.

14. The method of claim 9, wherein the consumer energy storage system comprises batteries.

15. The method of claim 9, wherein the consumer energy storage system comprises at least one fuel cell.

16. A method for managing power demand comprising:
measuring a level of power received from a power distribution grid to a consumer;
determining, based on the measured level, if the power distribution grid is in at least one of a brownout condition and a blackout condition; and
in response to the determining, powering an electrical device by a consumer energy storage system, wherein the electrical device is powered in a first configuration with a consumer energy storage system and is powered in a second configuration with the power distribution grid.

17. The method of claim 16, wherein the consumer is a residential, industrial or commercial consumer.

18. The method of claim 16, wherein the consumer energy storage system comprises batteries.

19. The method of claim 16, wherein the consumer energy storage system comprises at least one fuel cell.
